(19) United States
(12) Patent Application Publication
(10) Pub. No.: US 2017/0012706 A1
(43) Pub. Date: Jan. 12, 2017

(54) METHOD FOR SHORT-RANGE OPTICAL COMMUNICATION, OPTOELECTRONIC DATA CARRIER AND READ/WRITE DEVICE

(71) Applicant: Vladimir Iosifovich LIVSHITS, Moscow (RU)

(72) Inventor: Vladimir Iosifovich LIVSHITS, Moscow (RU)

(21) Appl. No.: 15/108,373

(22) PCT Filed: Dec. 25, 2013
(86) PCT No.: PCT/RU2013/001170

§ 371 Date: Sep. 30, 2016

(51) Int. Cl. H04B 10/2587

(52) U.S. Cl. CPC H04B 10/2587

(57) ABSTRACT

The invention relates to electronic data carriers having non-volatile memory, and to a method for short-range optical communication. The aim consists in creating a simple, compact, jam-resistant data carrier and a data read/write device. A primary source of radiation is placed in a first device, and a second optoelectronic device is used in a passive mode, in which it receives power as a result of photovoltaically converting the energy of an absorbed portion of the radiation from the first device and responds to a query from the first device by means of modulating a reflected portion of the radiation. The devices are brought into contact in such a way that a light guide is formed between an active structure of the first device, i.e. an optical transceiver, and an active structure of the second device, i.e. a target, said light guide concentrating radiation in a communication channel between the devices.

### CROSS-REFERENCE TO RELATED APPLICATIONS

The present application is US National stage application from PCT application No. PCT/RU2013/001170 filed on Dec. 25, 2013.

### FIELD OF INVENTION

The group of inventions with common inventive conception and common technical effect belongs to the methods and devices for information technologies based upon storage of relatively small volumes of data, e.g. personal or subject identification and/or authentication data, in electronic data carriers with non-volatile memory made in the form of independent mobile devices, e.g. electronic keys or electronic tags being connected to the tagged items, with recording/reading of the data being stored at the recorders/readers' touch of the carriers.

### PRIOR ART

The known kinds of data carriers being used in the specified information technologies, and, correspondingly, the methods and devices for communication thereof with recording/reading equipment (interfaces) are divided into two groups: contact (electric) ones and non-contact (field) ones.

In the first group, the closest functional analogue of the invention is the family of “Touch Memory” electronic identifying keys (TM—touch memory) being produced by Dallas Semiconductor under the iButton™ brand. The single-wire electric TM interface uses the “Touch Probe” (TP) contact probe (data collector) [1, 2].

The series of attractive performance of TM is ensured due to their unusual among the rest of the instruments of this group sealed stainless steel housing analogous in design to the housing of a “button” battery. The housing consists of the rim with bottom and electrically isolated cover. As distinct from the conventional contact data carriers, the TM memory contents are only accessed via two lines: the “ground” one and the bidirectional signalling one, at that the rim and the bottom are the “ground” contact, and the cover is the signalling contact. The TP probe, the shape of which is designed in such a way that it precisely interfaces the round housing of the TM, consists of the metal rim and the recessed central contact isolated with dielectric. The TM interaction with the TP is ensured on their momentary mutual touch when the TM cover contacts with the TP central contact and the TM rim contacts with the TP rim. Now, the widest use the TM/TP instruments find in the control systems of physical access to buildings and rooms, access to information resources and engineering means control, in the systems of automatic identification of subjects and objects by the unique code, and also in the systems of effecting of non-cash electronic payments.

But these instruments, like any other devices, the operation of which is accompanied with closing/opening of plug electric contacts susceptible to various adverse environmental effects, feature known disadvantages aggravated in this case by the fact that for the contact pair material stainless steel was selected. On the one hand, this material unconventional for low-current contacts and contacts working at low voltage enabled skipping of many process problems and reducing of the finished products' cost, but it is known that corrosion resistance of stainless steel is related to presence of relatively thin but highly strong passivating oxide film on its surface. Due to this, single slight touch of TM to TP is not always enough but shall be repeated with application of higher forces. Besides, it is well known how more difficult is to be a success when the instruments gets wet, e.g. from being caught by the rain or, far less, when dielectric fluids, e.g. fuel and lubricants, fall onto their contacting surfaces.

Completely free from such kind of disadvantages are the methods and devices of the second group having the not contact electric interface but the non-contact field (electromagnetic) one, and these devices, in turn, are divided into two sub-groups: radio frequency and optical ones.

The second group's first sub-group includes the technology of radio frequency identification RFID, ISO/IEC 14443 Standard non-contact smartcards, and also extension of the specified standard, the technology of wireless high-frequency short-range (˜10 cm) communication NFC (Near Field Communication) which became widespread in recent years.

By functional capabilities, the RFID technology as the technique of storage and acquisition of data intended for automatic identification of objects at production, merchandise in a shop, people, animals, property, documents etc. is commonly believed to be close to the marking technologies based upon optical techniques of recognition, particularly, bar coding, noting here as the most important advantage of the first one the possibility to work with changeable data [3]. The RFID tag is the transponder (TRANSmitter/resPONDER) consisting of the crystal of silicon integrated circuit (IC) including the responder, transmitter, and non-volatile memory, and the antenna connected to it being the loop antenna in the form of Archimedean spiral etched out of foil (for versions in the form of flat appliques), or the magnetic one in the form of coil wound by the insulated microwire onto the miniature cylindrical ferrite mandrel (for versions in the form of implantable bio-chips). Receiving energy from the radio signal emitted by a recorder/reader by means of own antenna, the RFID tag performs recording (updating) of data or responds with the signal containing useful data [4].

But use of the RFID tags, with all their advantages, is accompanied by serious security troubles related to personal privacy (respect for human rights). The main risks are related to the fact that RFID tags can stay operable even after merchandise is paid and brought out of a shop, and thus they can be used for surveillance or other indecent purposes not related to inventory functions of the tags. Extremely dangerous the situation is believed to be when RFID-tagged merchandise is paid by a bank card thus allowing unambiguous linking of this RFID's unique serial number with the buyer. Besides, the unique numbers of RFID tags can release the potentially hazardous information even after getting rid of the merchandise. For example, tags on re-sold or gifted goods can be used to detect the social circle of their former owner. The most serious concern of the security experts is induced by the RFID technologies of people's identification/authentication—due to technical capabilities of unauthorized access to the corresponding codes.

The smartcards including non-contact ones are much more functionally complicated instruments as compared to usual RFID tags, since their IC, as a rule, further comprise the microprocessing unit and the operating system, the monitoring device and access to its memory using cryptographic procedures, but structurally the non-contact smartcard is the complete similitude of RFID and uses the same radio communication technology for interaction with a recorder/reader [5].

Owing to such peculiarities, the people's identification/authentication technologies by means of non-contact smartcards are believed to be relatively safe (these are widely used including in modern electronic “biometric” passports), but physically, the radio communication channel is open (the data being transmitted, in principle, can be intercepted at sufficiently large distance), that's why unauthorized access to the codes being transmitted using the well-arranged and thoroughly planned hacking attacks may not be excluded with 100% probability. Apart from this, the data being stored in non-contact smartcards and RFID can be quite easily destroyed or made temporarily inaccessible by the existing means of radio electronic warfare (REW), for example, such as powerful pulse generators of electromagnetic emission or so called “jammers”.

The NFC technology actually consolidating the standardized interfaces of RFID tags, non-contact smartcards and relevant recorders/readers in one instrument, e.g. a cell phone or a tablet [6], brings nothing new into solving of the security problems resulting from the use of electromagnetic emission of radio frequency range in the communication channel, but it must be specified among the analogues of the invention as the precedent of interfaces concentration and, correspondingly, functions of heterogeneous devices presented earlier only separately from one another. For the same reason, there are grounds to specify among the analogues the so called “digital pen” [7], which is also usually a multi-function instrument intended, in the first place, for recording of the user's hand-written symbols and drawings, their digitizing and storing in digitized form in the own non-volatile memory. Similarly to the way in which the above specified relatively large (though portable) NFC-supporting instruments are the concentrators of radio frequency interfaces of not only the data carriers but also of recorders/readers, the shape factor of a digital pen which is much lighter and much more easy-to-carry as compared not only to a tablet but also to a cell phone, will be presented as the most reasonable for the concentrator of heterogeneous bidirectional reflex-and-optical interfaces.

To the second group's second sub-group of the known technologies of non-contact (field) short-range communication between the computer science devices where the electromagnetic emission of optical (particularly, infrared—IR) range is used as the transmission medium, the so-called Infrared Data Association—IrDA, or IR-port belongs, in particular [8].

Now, IrDA is the obsolescent solution which has been almost completely superseded by the more up-to-date radio-communication-based technologies, e.g. Wi-Fi and Bluetooth, but it deserves to be mentioned due to the fact that it is the precedent of use in such a context of the short-range optical communication lines. Yet until recently, with the IR-ports the most part of cell phones, laptops, and mini-computers was equipped; now they continue to build on the basis of the simplified IrDA—with unidirectional communication channel—only the remote control consoles (RCCs) for household appliances, particularly, TV sets, video players, and air conditioners.

The main (but not yet implemented) advantage of use of optical communication in this context as compared to radio communication lies in possibility in principle to create the functionally and structurally finished optoelectronic data carriers together with the components of their field interfaces (analogues of radio range antenna structures) in the micro-structural (and in future, nano-structural) size scale, including on common planar surface of one-piece optoelectronic memory ICs.

This becomes evident if we take cognizance that, for reasons of energy efficiency of electromagnetic waves' receipt/transmission it is required that the characteristic dimensions of receive-transmit structures (particularly, antennas) are at least commensurate with emission wave lengths equal—in optical range—to a micrometre fractions and units which is by a factor of 4-6 smaller than that of very-high-frequency radio waves. That's what explains for why only in the optical-range field communication systems one can do without any relatively large antennas and only presence of the solid-body (semiconductor—SC) optoelectronic instruments themselves to which photodiodes (receivers) are known to belong and light-emitting diodes (LEDs) including SC lasers (emitters) is sufficient.

Conventional division of these optoelectronic instruments into two specified groups is caused by the fact that overwhelming majority of known methods of optical communication—not only long-range but also short-range—is constructed in the way that in cases where bidirectional communication is required, on each side the pairs of optoelectronic instruments are used compulsorily, one only being for emission, and the other one solely for receipt. This has objective preconditions: despite obviousness of the fact that if a photodiode (receiver) is made of SC with predominantly emitting re-combination of charge carriers, it will to any extent possess reversibility (possibility to work as the emitter), but its parameters due to, in particular, different requirements to emission absorption in SC will result mediocre—at least for one of the functions.

As a rule—particularly, in hardware implementation of IrDA systems, except for RCC where unidirectional communication is required, the optical pair on each side comprises the emitter and the receiver separated not only functionally but also structurally. However, for applications in fibre optic communication lines (FOCL), there were proposed the integrated optoelectronic instruments comprising the emitting and the photo-sensitive diodes formed in one SC crystal, for example [9].

The structure of this and similar to this optoelectronic instruments is highly complicated: usually, they comprise many limiting and further SC layers having different conductivity types, the only purpose of which is to ensure maximum isolation between the received and the transmitted optical signals in order to obtain the possibility of duplex operation mode (when receipt and transmission are performed simultaneously). This sophisticates significantly the production technology of such instruments as compared to isolated emission and receipt diode structures. That's why the cost of one such instrument turns out to be much higher than the cost of usual optical pair which in overwhelming majority of cases makes their use economically unreasonable, except for FOCL with advanced requirements to traffic.

Since the requirements for the method of optical communication for the above mentioned scopes are such that the duplex operation mode is unnecessary, and since interaction of the sides in similar cases is as a rule arranged on “Master-Slave” (hereinafter referred to as M-S) principle [2], half-duplex is sufficient (either receipt or transmission via the bidirectional line).

This opens up the opportunity to use here the special methods of optical communication within close range and adapted solely for solving of narrow circle of tasks for their applications and inherently unsuitable for anything else of conventional optical communication areas (e.g. to arrange traffic on a long-length FOCL). Such a method together with design and process ways of implementation thereof is described in [10]—the engineering solution closest to those being claimed in all the set of features and in which the concept of their key distinction, reflex-and-optical interface (ROI), was disclosed for the first time ever in the embodiment feasible but of very restricted application, as it will be shown below.

Formally, the subject of [10] is the device, the silicon-based non-contact integrated microcircuit (NcIMC) which is the functional analogue of RFID and intended for integration into laser optical discs (CD/DVD) in order to protect against unauthorized reproduction. Its unique quality lies in the fact that a separate device for reading of data recorded in the NcIMC non-volatile memory is not required since for this serves the laser optical head present in the disc drive. But in practice, in order that the silicon-based NcIMC in which emission re-combination is impossible would give optical response, it turned out necessary to propose the new method of short-range optical communication and the corresponding interface—one of ROI embodiments.

The method of short-range optical communication between two optoelectronic devices interacting on the M-S principle according to [10], is based upon the fact that the primary emission source is only placed into the first, M-device, and the second, S-device is used in passive mode under which it receives power as a result of photovoltaic conversion of energy of absorbed part of primary (incident) emission being sent by the M-device at request of the S-device, and, in its turn, responds the request by means of modulation of the secondary (reflected or in other method returned to the M-device) part of its emission.

There are reasons to recognize reflection with modulation of the secondary emission on the slave side, instead of generating primary emission on both communicating sides, to be the breakthrough solution in the field of optical communication, since it allows, in principle, to construct bidirectional channels even in cases when the slave side is physically unable to work in active mode (i.e. to generate emission itself).

But performance capacity of this method in the known solution was implemented incompletely, to the extent only sufficient according to conditions of the certain task. The NcIMC, the S-device, was thought of as a kind of “interactive track” in the CD/DVD root part addressing to which is performed according to monophysical principle with the contents, i.e. during its motion in the course of disc rotation when the focused laser beam of optical head, the M-device, interrogates (scans) in sequence the ranges of separately located on the NcIMC surface structures, either only receiving or only returning emission. That's why the necessary condition of addressing the NcIMC non-volatile memory is motion when the above mentioned devices move relative to one another. Thus, the functional capabilities of, in principle, any ROI the construction of which is based upon the method of short-range optical communication described in [10] get extremely shrunk.

### SUMMARY

The object of the invention is to combine in the new set of instruments of advantages and to eliminate disadvantages of two known groups of data carriers and recorders/readers—with contact (electric) and non-contact (field) interfaces—through enhancement and new hardware implementation of the concept of ROI being contact by method of application and non-contact by operating principle. To do this, first, there has been proposed the multi-purpose method of short-range optical communication between various M-devices—requestors, and S-devices—responders (transponders) without own power sources, which in particular allows constructing of ROI requiring no movement of the data carriers (S-devices) relative to the corresponding recorders/readers (M-devices). Second, the embodiments of structures thereof based upon different physical principles and possessing different performance have been proposed. The result linked to solution of this object is combination in the new set of instruments of formerly presented only separately functional capabilities of their contact and non-contact analogues, in particular, Touch Memory, RFID and non-contact smartcards, with absence of their disadvantages in the field of personal sphere security and as regards resistance to external effects.

The set object as regards the method is solved by that in the known method of short-range optical communication between two optoelectronic devices interacting by M-S principle in which the primary source of emission is only placed into the first—M-device, and the second—S-device is used in passive mode at which it receives power as a result of photovoltaic conversion of energy of absorbed part of primary (incident) emission being sent by the M-device at request of the S-device and, in turn, responds the request through modulation of the secondary (reflected or in other method returned to the M-device) part of its emission in order to accomplish data exchange between the devices in accordance with the established protocol, both devices are brought to touch in the way that in between the active structure as part of the M-device—optical transceiver, and the active structure as part of the S-device—target, an optic guide would form concentrating emission in the channel of communication between the devices and limiting its propagation into the external environment, upon which by start command being generated by the M-device, the data exchange is accomplished.

Despite resemblance of such method of optical communication and hardware components thereof with one of the above described analogues, IrDA, there exist the drastic distinctions facilitating achievement of the specified result: optical transmitter in the IrDa M-device, e.g. RCC, is the outwardly opened wide-angle emitter, and the light-detecting structure as part of the S-device (a photodiode, as a rule) is not in the least the target (an object exposed to concentrated influence in case of accurate catch) but a sensor, since to actuate the IrDa S-device it is sufficient the extremely small share of the M-device scattered emission being collected by a light-detecting device no matter where it is located within the admissible distance from the emitter and no matter orientation relative to it. But, according to the invented method, concentration of the primary emission using the optic guide in the channel of communication between the devices and its precise addressing to the target, limiting energy leak into the external environment, are the measures allowing to ensure sufficiency of the energy which reached the S-device, not only for reliable detecting of data by it but also for its feeding, with elimination of possibility of the data malicious intercept from outside.

Here, as the target in the S-device there is used the functional area of reversing (reversible) optoelectronic instrument capable of working both as the primary emission receiver (energy converter) and as the secondary emission electrically controlled transmitter (modulator). In fact, the instrument of such capability is the functional analogue of the transceiving radio antenna for optical range. Despite the fact that a common LED can, in principle, work in this guise, the mutually inverse effects of photoelectric conversion in it has not been studied in applied aspect, according to the data available.

It is reasonable to generate automatically in the M-device the start command initiating data exchange, for which purpose the M-device shall include the sensor of pressure exerted to it. Use of the set of optoelectronic devices exchanging data automatically at touch, in practice will not differ from use of the above described analogue, the TM, but will trigger many advantages related to electric non-contact.

The optic guide being formed between the active structures of the M-device and the S-device at their touch, in the simplest embodiment of the method can have common channel for the primary and the secondary emissions. However, the task of separation of request and response signals in the M-device, with presence of the optic guide, cannot be solved in the same way as it is solved in the above mentioned M-device for NcIMC, the laser optic head of the CD/DVD disc drive, through use of dichroic mirror and polarization effects at reflection since position of the beam polarization plane upon beam's passing through the optic guide can change. That's why it is reasonable to separate the primary emission request signals and the secondary emission response signals by time through construction of the S-device circuit board in the way that the leading edges of response pulses be formed behind the falling edges of request ones. In this case, each response pulse of the S-device will come to the M-device not earlier than it finishes sending of the request pulse playing the role of a strobe (i.e. asynchronously with it), that's why a ROI based upon such a principle will hereinafter be referred to as the asynchronous one (AsROI). The certain example of the S-device constructed using such a method will be given below (in summary as regards the device, the optoelectronic data carrier with AsROI).

The optic guide with common channel for the primary and the secondary emissions can be formed, in particular, through connection to one of the devices of a hollow tube with reflecting inner surface enveloping the active structures of both devices: of the first—permanently, and of the second—temporarily (for the period of touch). This embodiment is reasonable for the described below data carriers with AsROI made in the shape factor of miniature optic guides in plastic casing with shortened axial leadouts and the corresponding recorders/readers (M-devices) similar to coin boxes of vending machines.

Besides, the optic guide with common channel for the primary and the secondary emissions can be formed through connection to one of the devices of a rigid fibre optic box being the bundle of laid in parallel and working together fibre optic guides in common protective jacket, sharpened and/or rounded on the external end which shall touch the optically transparent window (a cavity of the corresponding rounding radius in the optically transparent window) of the second device. This embodiment is reasonable when one of the devices is made in the shape factor of a digital pen (or stylus) since the fibre optic box by its shape can be a rod sharpened (in particular, tapered) and rounded on the end, externally undistinguishable from a ball tip. With a cavity present in the second device's window, correct selection of point of touch with the first one is simplified and accompanied by tactile response thus creating convenience for a user. If the S-device (the data carrier) is made in such a shape factor, its design, as regards optoelectronics, can also be similar to a LED. If in the shape factor of a pen a recorder/reader is made, for the data carrier more reasonable is another version—in the form of a pellet.

The most important functional capability of the optic guide in the form of rigid fibre optic box being the bundle of fibres laid in parallel, not implemented in such embodiments of the method is in the fact that using it, the primary and the secondary emissions can be separated not only in time but also in space. In such embodiment of the method, there can be constructed the most interesting and in many points record-breaking, in all the set of technical and economic parameters, embodiments of the optoelectronic data carriers—the ones with synchronous ROI (SROI) described below.

To do this, to the M-device the fibre optic box shall be connected being the sharpened and/or rounded on the external end with which the optically transparent window (cavity of the corresponding rounding radius in the optically transparent window) of the S-device shall be touched, bundle of laid in parallel but working separately fibre optic guides in common protective jacket. Namely, the group of fibres located centrally (in the core) of the bundle is reasonable to be used for channelling of the primary emission, and the group of fibres located peripherally (in the circumferential zone adjacent to the jacket) of the bundle—for channelling of the secondary emission. Reasonability of such separation is due to the fact that shaping of the secondary emission through reflection from the target and modulation of the primary emission is accompanied by its scattering, that is why it is more reasonable to collect the secondary emission from the extended zone adjacent to the bundle jacket, and the effect upon the target shall to the contrary be concentrated, that is why it is more reasonable to direct the primary emission along the narrow core of the bundle.

It is reasonable to make on the internal (connected to the M-device) end of the optic guide with separate channels for the primary and the secondary emissions the shank of cross-section smaller than cross-section of its central part—such that it would accommodate only the core intended for the primary emission channelling, and the butt-ends of the peripheral fibres intended for the secondary emission channelling would stay in the zone of step-wise transition from the optic guide central part to the shank. Here, the M-device optical transceiver shall be constructed with separate receiving and transmitting structures (optoelectronic instruments) according to the optical pattern ensuring separation of the primary and the secondary emissions by the corresponding instruments with sufficient level of optical isolation between them. The step-like profile of the optic guide allows separating of the receiving and the transmitting structures by its axis thus ensuring the possibility to use as each of them the simple and not combined optoelectronic instruments with the required functions. One of the examples of embodiment of the described method in the M-device pattern is given below.

The proposed short-range optical communication method described above in every detail of its embodiment is in principle invariant as regards functional belonging of the S- and M-devices participating in it—the only important thing is that interaction between them would be accomplished by the “master-slave” principle. As for the group of inventions being summarized, this, as regards the devices, include the most relevant embodiments of these, and in each of them the S-device is the optoelectronic data carrier (ODC), and the M-device is the recorder/reader (REC/READ) for it. That is why further on in the text the acronyms ODC and REC/READ will play part of the S-device and the M-device, accordingly.

It is reasonable to consider first the compromise ODC embodiment which is hybrid rather than single-piece (single-crystal). In this embodiment, implementation of such in truly microscopic scale dimensions with complete rejection of assembling operations is impossible but for it no research and developments of new optoelectronic instruments must be done and the existing hardware components are sufficient. The key points of this ODC option are AsROI and formation of the secondary emission not by the direct (optical) reflection of the primary (incident) emission from the corresponding layer of the target but by the above stated “other method of its return”: indirect (electric) reflection passing through the current circulating along the so called “reflection contour” being considered below.

As the prototype for all the ODC options—and for the method also—the NcIMC (instrument) [10] is considered being the recorder/reader (REC/READ) receiving repeater receiving its power as a result of photovoltaic conversion of energy of emission being sent by the REC/READ at ODC request and responding the request through modulation of the secondary (reflected or in other method returned to REC/READ) emission.

The invention object specified above is solved in the first embodiment through the fact that the ODC being the REC/READ receiving repeater receiving its power as a result of photovoltaic conversion of energy of emission being sent by the REC/READ at ODC request and responding the request through modulation of the secondary (reflected or in other method returned to REC/READ) emission, and is made in the form of hybrid micro-assembly comprising the silicon IC with circuit boards of non-volatile memory to which there are connected in the form of closed loop circuit the optically active diode structure of material of, for example A₃B₅ group enabling it to operate both in photodiode (conversion) mode and in LED (emitting) mode, and the inductance (micro)cell. Its inductance is determined by the criterion of sufficiency of energy accumulated in its magnetic field for one current pulse, for formation of response pulse of light being emitted by the structure in LED mode upon completion of the brightening pulse due to the fact that the current in the circuit containing inductance cannot cease immediately.

Thus, the closed loop circuit consisting of the diode structure with reversing activity and the inductance cell is the reflection circuit, the functional analogue (equivalent) of the reflecting (mirror) surface, with the essential difference that reflection of the secondary emission information constituent from it occurs not immediately (synchronously with irradiation) but with delay (asynchronously): when the action of irradiating pulse (but not the current generated by it in the closed loop) has ceased already. Naturally, there takes place also the secondary emission spurious synchronous constituent conditioned by inevitable optic (direct) reflection from the diode structure, but it imperceptible since the REC/READ patterns with AsROI are such that in every moment of time they work either only for receipt or only for transmission.

To control the reflection contour, the silicon IC with non-volatile memory circuit boards included into such an ODC shall comprise the electronic key disconnecting the loop in cases when the binary digit of the digital sequence being transmitted to the instant interval is such that formation of the response pulse is not required.

The described circuitry solution in which relatively strong currents forming the secondary emission pulses circulate via the reflection contour short loop which is external against the micropower IC performing here only the functions of data storage and control, allows to optimally solve the task of control of LED as the low-resistance load from the IC side by moving it outside the pulse current source. Besides, with small difference of potential which can be ensured by the LED structure in the receiving (photovoltaic) mode, static accumulation of the sufficient charge for response pulses in the traditional way (in the capacitor) would be accompanied by technical problems much more serious than use of inductance cells in the reflection contour for dynamic accumulation of charge. For these reasons, just the ODC structure with AsROI facilitates to the maximum extent the achievement of the specified technical effect.

In the first of the recommended shape factors of such ODC, the IC and the diode structure are mounted in perpendicular planes: the first one is on the side surface and the second one is on the butt-end surface of at least one of leadouts. Then, these instruments, similarly to the batch-produced so called “flashing” LEDs, the hybrid micro-assemblies of the diode structures and IC of multi-vibrators, are jointly poured (mould) with the optically transparent compound. The mould for pouring, in particular, can be a cylinder with convex bottom being the focusing lens with focus on the diode structure location. The inductance micro-cell is installed outside on the leadout stretches of minimum length released outside the transparent pouring (moulding).

It is expedient to enclose such ODC for several applications, in particular, vending, into the collar holders ensuring ease of handling them and/or their attachment to the items being marked, and to protect against unauthorized actions with erased-when-removed adhesive appliques with protective (hard-to-copy), e.g. holographic, drawings enveloping the collars. At the level of carriers in these patterns, it is wise to make perforations which tear at the first action of recording/reading (the carrier's initialization) by end users. To unauthorized actions against which the patterns can protect belong, in particular, the non-affecting-appearance transfer of the carrier being the unique merchandise marker-label from one merchandise to another (e.g. from a legal one to an infringing merchandise), repeated attachment of the used carrier to another item, access to the unique (including key) data contained in the carrier before this carrier legally (e.g. after payment) finds the owner and is initialized with introduction of additional data (e.g. seller's details and date of sale) into it. ODC protected in such a way can be not only the marker guaranteeing the merchandise authenticity but in future (in the course of the merchandise operation) can serve to its owner as, for example, warranty sheet automatically filled in. It is obvious that for analogues, contact and non-contact (radio-frequency) ones, such simple and efficient protection measure is inapplicable: to the first ones, one can connect without affecting the appearance through the adhesive pattern with thin needle probes, and it is impossible to reliably obstruct arrival of radio waves to the second ones.

It is expedient to enclose such ODC for other applications, particularly, as personal identifiers and/or keys for protected data transporting, into the digital pen (stylus) tapered tip and to mate inside with passing along the tip axis rigid fibre optic box being the bundle of laid in parallel and working together fibre optic guides in common protective jacket, the external butt-end of which, similarly to a ball tip, is machined to a sphere. In these cases, it is reasonable to pour the ODC with optically transparent compound in the cylinder-shaped mould, on the contrary, having concave (equipped with cavity) bottom ensuring mating with internal butt-end of the fibre optic box machined in the same way as the external butt-end. To get identified or to enter own personal data (e.g. PIN) into the terminal device using the ODC finished in this way, it is enough for a user to touch slightly at arbitrary (varying within wide range) angle with his/her pen (stylus) tip the specified place on the terminal device panel which is outlined with the special window having the mating cavity. Such a procedure, obviously, turns out to be easier, more reliable and safe as compared to the procedure based upon use of the known analogues, both contact and non-contact ones.

In the second of the recommended shape factors of such ODC, IC and diode structure are mounted in parallel planes on opposite faces of two lead frames put together with rear sides in the way that leadouts subject to internal connections turn out to be superimposed (overlaying), and are poured (moulded) together with optically transparent compound in the form of miniature short cylinder (pellet). The frames' external contours and the leadouts not subject to external connections (process ones) are removed after pouring (moulding).

As distinct from the first shape factor focused mainly on free pouring with optically transparent compound in open cluster-type moulds of silicone elastomer, here the basic technology is moulding in metal moulds similar to those being used in large-scale production of IC in DIP housings and analogous to these. Separation of IC and the diode structure into two sub-assemblies with own lead frames being met only at finish, in the mould for moulding, is also preferable for the conditions of large-scale and gross production, especially by cooperation. The main advantage of this shape factor is substantially smaller, as compared to the first embodiment, axial length of ODC optoelectronic boxed which opens possibilities for creation of special final structural versions of the instruments.

It is expedient, in particular, to enclose such ODC into open from the side of tubular shanks heads of hollow rivets or latches (buttons) as part of personal-use items (items' jackets) being equipped with them, and to make the inductance microcells on circular (toroid) cores and to install from outside in one plane with ODC located in the cores' central holes. The objects being equipped with such ODC can be, for example, wallets (porte monnaies) with compartments for bank cards, in which ODC perform functions of protected storage of PINs (only accessible for reading with the owner's digital pen which he/she must store separately); cases for smartphones and minicomputers—for protected storing of passwords—up to articles of clothing, in the known only to him/her button (buttons) in which the owner can secretly and reliably store the backup copies of his/her passport, medical data, bank details etc. during travel. Besides, with the low-profile rivets with ODC there can be equipped the merchandise labels, technical passports, compliance certificates, and other documents. Making of inductance cells on circular cores and installation of these in one plane with ODC are the structural measures minimizing the item axial length.

As against the first ODC shape factor, one of the recommended versions of which is the pen (stylus) tip, for ODC in the form of rivets, the other instrument of the set, REC/READ, can be made in the form of a pen (stylus).

Further, the second, the most perfect, including the single-piece (completely of silicon) embodiment of ODC is considered, in which it is possible to implement of such in microscopic scale dimensions with complete rejection, for several versions, of assembling operations. The key points of this embodiment are the SROI and formation of the secondary emission through direct (optical) reflection of the primary (incident) emission from the corresponding layer of the target. Along with those of being further disclosed physical principles of its modulation which are operable without any doubt due to the fact that within them, the approved solutions are applied for their intended purpose—the novelty only is in specific points of their adapting to the tasks—one of them bears the certain share of engineering risk since it is not the ready solution known from the prior art but the scientific forecast though consequential from the confirmed physical laws. The main advantage of this principle is feasibility within the basic technologies of solid-body electronics without necessity to develop new processes and materials.

The above stated invention object in the second embodiment is solved through the fact that ODC being the REC/READ receiving repeater receiving its power as a result of photovoltaic conversion of energy of emission being sent by the REC/READ at ODC request and responding the request through modulation of the secondary (reflected or in other method returned to REC/READ) emission, comprises the non-volatile memory circuit boards and the optically active diode structure working solely in photodiode (converting) mode, and at least one further structural and/or circuitry component ensuring modulation of the emission reflected from the diode structure, at that, of all the above mentioned components at least the non-volatile memory circuit boards are implemented as part of the silicon IC. The fact that here the optically active diode structure, as against the first embodiment, shall not be the reversing light converter/emitter but is intended for operation solely in photodiode (converting) mode and for this reason can be made of silicon, is the key point of the second embodiment allowing to the maximum extent to implement all and any components as part of the silicon IC.

Technologically, the simplest way to accomplish this ultimate goal is if the specified further components are made solely as circuitry ones—as part of a governor controlling in the transmission mode the electric load of the diode structure for the purposes of modulation of the emission reflected by it by the parameter sensitive to the share of absorbed energy extracted from the structure in converted (electric) form. The phenomenon lying in the fact that the load of photovoltaic converter to certain extent effects upon at least one parameter of the emission reflected by it, has not been yet observed, according to the data available, and remains to be discovered and studied—but the following arguments can be raised in favour of its existence.

Historically, in all the previously accomplished research of photo-effect per se the researchers were only interested in what energy is led to the photocell in electromagnetic (optical) form and what energy is led from the photocell in electric form. Here it was not taken into account that the photocell just as any real body cannot be absolutely black and for this reason, far from all electromagnetic energy being led to it was absorbed completely being converted into heat and electricity, but some part of it certainly returned as the secondary light emission. This phenomenon being traditionally considered as harmful was not examined specially but only means of struggle with it were proposed—in particular, through applying of anti-reflection coating.

On the other hand, it is clear that an idle-running (not drained) and connected to the external electric load photovoltaic converter cannot reflect uniformly the emission coming into it since the delivered energy which in the first case effects only locally being absorbed by photo-sensitive layers and reflected from them, is partially removed (extracted) in the second case, that's why there shall remain less energy for reflection as compared to the first case. In both cases, in photo-sensitive layers (p-n transition) of the converter there take place the competing processes of electron-hole pairs generation (with absorption of energy) and re-combination (with liberation of energy)—but with the closed external circuit, owing to discharge of part of electrons and holes on the corresponding electrodes generation dominates over re-combination, and with the opened external circuit, owing to deceleration of the charge carriers moving towards the electrons by the counter electric field which is the consequence of difference of potential, the generation and re-combination processes come into dynamic equilibrium. It is obvious that this difference would be more perceptible not on silicon but on a material with predominantly emitting re-combination of the carriers: such a converter in the unloaded state would generate more secondary emission (luminesce stronger) as compared to the loaded one, but it is clear that regardless of the converter's material, absence of correlation between at least one parameter of the reflected emission and state of its electrical load conflicts with the law of conservation of energy.

Thus, if a photovoltaic converter close to ideal one was successfully created, it, at connection of matched load to it and uniform lighting, would darken notably due to the fact that finally, there would remain much less energy for reflection. To one extent or another, this effect shall be inherent also to actual converters including photodiode structures, consequently, the correct physical experiment shall confirm it and reveal the reflected emission parameter which is maximum informative, i.e. sensitive to the share of absorbed energy extracted from the structure in converted (electric) form and can be detected with confidence.

It is not compulsory that as the informative parameter, the reflected emission intensity (amplitude) would be taken—alternatives are admissible related, e.g. with shift of spectral composition of its infra-red component due to variation of heating of near-surface layers of structure, and so on. Only after this it will be possible to formulate the specifications to REC/READ detecting patterns for ODC with this modulation principle.

In certain versions of the second embodiment of ODC, regardless of the modulation principle used in them, it is reasonable to implement the optically active diode structure as part of the silicon IC on its common planar surface with the non-volatile memory circuit boards. Such versions are the most simple structurally and technologically.

In cases when it is required to utterly miniaturize ODC in area, it is reasonable to implement the optically active diode structure as part of the silicon IC on its second (rear) planar surface—opposite to the one on which the non-volatile memory circuit board are located. However, such a version required solving of the complex technological problem of creation of insulated electric connections between components located on the opposite sides of a crystal.

The above-described principle of secondary emission modulation to implement which it is not required to add the diode structure with any structural components lacking by usual photodiodes, surely is of the most interest from scientific point of view and the most promising from practical point of view. But, due to the fact that it is not yet studied properly, the alternative option shall be considered, more complicated technologically but certainly operable and physically feasible. In it, the optically active diode structure comprises the external semi-transparent electrode included into the circuit board as common for modes of receipt and transmission, over which using the known process techniques there are applied further structural components in the form of electrically controllable optically active layer made, for example, of ferroelectric or liquid-crystal dielectrics and also of the second semi-transparent electrode included into the circuit board as the modulator for the transmission mode.

Thus, the target of such ODC is the combined optoelectronic instrument composed of two known and for this reason certainly operable instruments laid one onto another, the modulator and the converter, with common delimitating semi-transparent electrode. For it, the single-piece integrated version at which forming of all the further components is included into the IC manufacturing route is not always reasonable. At least one of them can be located on the transparent dielectric substrate carrying the IC, and be connected to its circuit board through the assembling techniques being used in the hybrid-film technology.

Summary of the proposed REC/READ solutions for all the ODC embodiments considered above, observing the logics in representation of material related to the individual inventions of the group, is made in comparison with the above mentioned laser optic head of CD/DVD disc drive—REC/READ for NcIMC [10], the common prototype of the whole group of inventions. The essential features, in this context, are the optical transceiver (here, consisting of laser and battery of photodiodes) sending the primary emission to ODC (here, to NcIMC) at its request, and receiving the secondary (here, reflected) emission from ODC at its response, and also implemented by some method or another the system of separation of request and response signals (here, constructed upon a dichroic mirror).

The structurally simplest REC/READ is for ODC with AsROI in which the request and the response signals are not required to be separated in space. Such REC/READ comprising the optical transceiver sending the primary emission to ODC at its request and receiving the secondary (reflected or in other method returned to REC/READ) emission form ODC at its response, and the system of separation of request and response signals, according to the invention, comprises common for transmission and receipt modes optically active diode structure of material of, e.g. A₃B₅ group, allowing it to operate both in LED (emitting) and in photodiode (converting) modes. In this way there is implemented, in respect to REC/READ, the same principle of minimization of quantity of active components—on the basis of use of single diode structure with reversibility property—which was summarized above in respect to ODC. For temporary separation of the request and the response signals, the switch box electronic circuitry is enough which alternatively connects this diode structure to the request signals amplifier output or to the response signals amplifier input.

In more complicated way, the REC/READ for ODC with SROI is organized. Such REC/READ comprising the optical transponder sending the primary emission to the ODC on its request and receiving the secondary (reflected or in other method returned to REC/READ) emission from the ODC at its response, and the system of separation of the request and the response signals, according to the invention, comprises the optical system of their spatial separation. It is made in the form of a section of rigid fibre optic box being the bundle of laid in parallel fibre optic guides, which is sharpened and/or rounded on its end, and on the internal end comprises the shank of cross-section smaller than that of its main part. This cross-section is selected such that it shall only accommodate the core intended for channelling of the primary emission, and the butt-ends of peripheral fibres intended for channelling of the secondary emission stay in the zone of step-wise transition from the main part to the shank. The shank passes through the hole in at least one mirror tilted relative to optical axis—in the way that the butt-ends of peripheral fibres be displayed onto the photo perceptive surface of at least one receiving (converting) instrument of the transponder installed opposite to the mirror near the fibre optic box, and the transponder's transmitting (emitting) instrument—a LED or a laser—is installed on its butt-end brought outside the mirror. It is obvious that in such a way the problem is solved: the emission of the transmitting instrument cannot fall on the receiving instrument otherwise than go outside along the core on the external end of the fibre optic box, reflect from anything that supports it or towards what it is directed (to the cavity in ODC window, and in general case, to any supporting surface) and, being scattered during reflection, return via the peripheral fibres as the secondary emission.

If the above mentioned mirror is single, there occurs the effect of shading by the shank of the butt-ends of part of the fibres of peripheral zone behind it (relative to the receiving instrument). To avoid this, it is reasonable to pass the fibre optic box shank through central (intersecting the apex) hole in the pyramid with mirror facets opposite to each of which there is installed the individual receiving instrument. It is obvious that shading in such a system is in principle excluded.

To the advantages related to use of several receiving instruments instead of one in the REC/READ, belongs the possibility to recognize the image being formed on the internal butt-ends of peripheral fibres, like on a screen, due to different conditions of their illuminance on the external ends including details of the supporting surface texture. If the REC/READ pattern here comprises the dedicated to image processing digital signal processing unit (DSPU), this will allow it to operate in real time—as the further option, independently of communication with the ODC—in the mode of graphic manipulator (analogue of optical mouse). For this, to the DSPU input there shall be delivered the digitized image of the fibre optic box circumferential zone obtained from several receiving instruments (for pyramid-shaped system of mirrors) or from at least one receiving instrument made in the form of luster-type matrix. This image is obtained under conditions of illumination of the supporting surface, through the core of the fibre optic box operating in continuous mode (illumination mode) by the transmitting instrument. The customer value of this option turning such REC/READ into a multi-function computer accessory is absolutely obvious.

The most reasonable is its version in the form of a pen (with additional pen point). To avoid wires, it shall comprise the independent battery and also the standard module of wireless radio frequency interface (e.g. Bluetooth) for communication with the host computer. The pen point and the optical point can be located on different ends of such a pen, at that, for example, the first one can be under a cap.

### BRIEF DESCRIPTION OF DRAWINGS

FIG. 1 shows the block diagram of ODC with AsROI, with conditional outlining of the main components belonging to the reflection contour and the power supply.

FIG. 2 shows the family of oscilloscope pictures explaining the operation of such a reflection contour: formation of pulses of the secondary emission (in the bottom) influenced by the primary emission pulses (on the top) through the pulses of current circulating within the contour (in the middle).

FIG. 3 gives the design of such ODC in the version in which the IC and the diode structure are mounted in perpendicular planes.

FIG. 4-6 give its protected external decoration recommended for vending applications: section (FIG. 4) and views with partial sections (FIG. 5, 6).

FIG. 7, 8 give the design of REC/READ for ODC in protected external decoration (FIG. 4-6) with optic guide with common channel for the primary and the secondary emissions in the form of a stretch of a tube with reflecting inner surface: assembled representation of the front panel (FIG. 7) and section of REC/READ with conditional outlining of the essential components of its pattern and design (FIG. 8).

FIG. 9, 10 illustrate the application as the LEDs with common channel for the primary and the secondary emissions of the rigid fibre optic box being the bundle of laid in parallel fibre optic guides in common protective casing (FIG. 9—cross-section) sharpened and rounded on the external end which shall touch the cavity in the window of a device comprising no optic guide (FIG. 10—longitudinal section).

FIG. 11 gives the design of ODC as per FIG. 3 modified for application of such an optic guide in it, and

FIG. 12 gives its external decoration in the form of conical tip of a digital pen (stylus).

FIG. 13-15 give the design of the ODC with AsROI in structural version in which the IC and the diode structure are mounted in parallel planes: the view in the plane of the diode structure location (FIG. 13), the view in the plane of the IC location (FIG. 14), and the cross-sectional view (FIG. 15). FIG. 16, 17 show the external decoration of such an ODC in the form of opened from the side of tubular shank of head of a hollow rivet or latch (button) as part of a personal-use object (object's jacket) being equipped with it:

FIG. 16—longitudinal section, and

FIG. 17—cross-sectional view demonstrating the inductance microcell of the reflection contour, and also the special method of its winding onto the toroidal core.

FIG. 18, to illustrate the concept of ODC with SROI, gives the cross-section of its target, the silicon-based optically active diode structure operating solely in photodiode (converting) mode, with entire set of further structural components ensuring modulation of the emission reflected from it.

FIG. 19-21 give the skeleton form of the embodiments of structural version of ODC with SROI in the form of single-piece different in location of the target: in the centre of face planar surface (FIG. 19—topology), on the edge of the face planar surface (FIG. 20—topology), and on the rear planar surface (FIG. 21—cross-section).

FIG. 22-24 show the skeleton form of the embodiment of structural version of ODC with SROI in which the modulator's further structural components, the optically active dielectric (in this embodiment, the liquid one) and the external semi-transparent electrode, are moved outside of the silicon IC: the IC topology (FIG. 22), the ODC cross-section with the specially configured dielectric substrate encapsulating it (FIG. 23), and the ODC longitudinal section showing the contacts of the semi-transparent electrode.

FIG. 26, 26 give the example of installation of ODC of such structural version into an object being equipped with it (in this example, the metal one): blind hole in the form of collar (holder) with shoulders for curling (FIG. 25) and the very same upon placement of ODC into it and curling of the shoulders (FIG. 26).

In FIG. 27, the longitudinal section gives the skeleton form of the REC/READ for ODC with SROI comprising the optical system of spatial separation of the request and the response signals in the form of the stretch of the rigid fibre optic box with thinned shank passed through the system of mirrors (in this example, consisting of one tilted mirror), and decorated in the form of a pen (stylus) conical tip.

FIG. 28 (to the abstract) gives the skeleton form (in various scales) the REC/READ and ODC with SROI interacting through electromagnetic emission quants moving in both directions, at that the ODC main structure, the target, is outlined.

### EMBODIMENTS

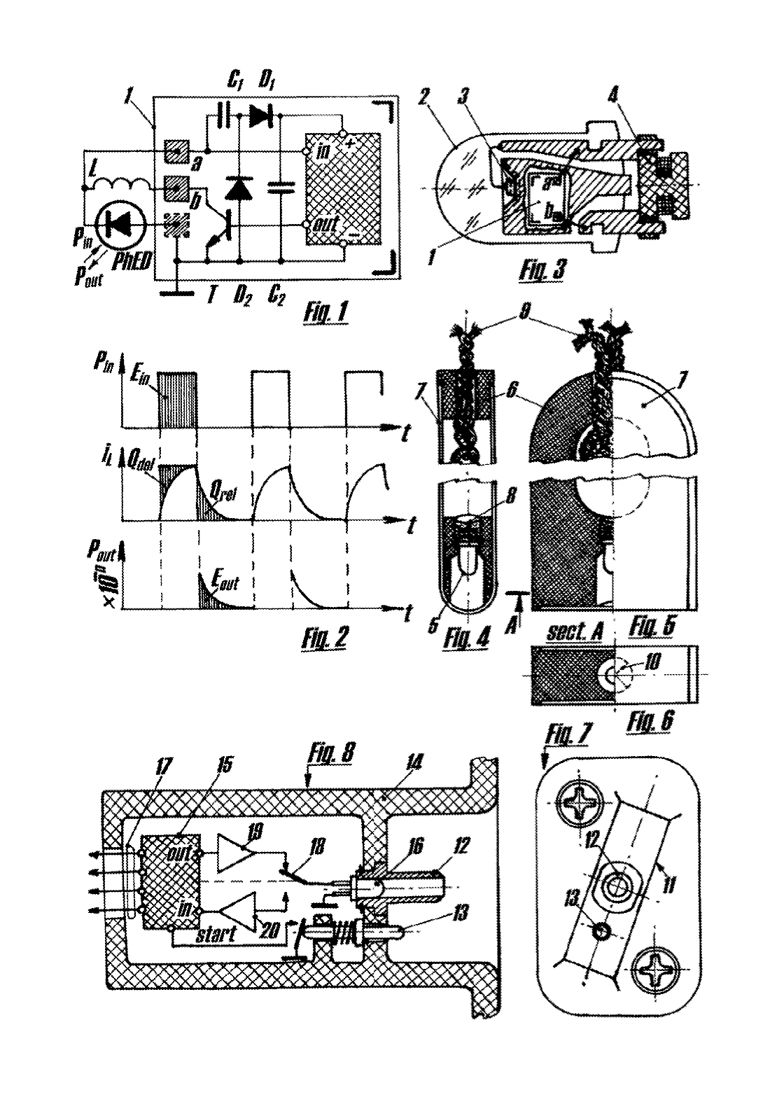

The hybrid micro assembly of ODC with AsROI (FIG. 1) consists of the silicon IC 1 and two attached discrete components, the diode structure PhED with reversing optical activity made of, for example, a material of A₃B₅ group (its non-conventional designation PhED—Photo-Emission Diode—reflects the unity of its functions as a photodiode and a LED—Light-Emission Diode) and also of the inductance (micro)cell L. For attachment of the discrete components, the IC comprises three contact pads as follows: a, b, and “common electrode” (in FIG. 1—in the bottom), at that the first two are located on the face (planar) surface of the IC, and the latter is the contact to the substrate (the silicon crystal) located at the back (rear) side of the IC. As part of the IC, there are implemented the main part—the logic unit with the non-volatile memory circuit boards, designated in FIG. 1 with hatched rectangle with conditionally outlined contacts for data input (sign of the mode—recording/reading, access codes, updates etc.) at addressing the ODC—in, for data output (service commands, digital sequence being stored etc.) at ODC response—out, delivery of supply voltage—“+” and “−”, and also related to these contacts auxiliary components—the diodes D₁, D₂, and capacitors C₁, C₂ belonging to the power supply, e.g. a voltage-double rectifier assembled as per the Schenkel-Willard pattern.

The transistor T is, for example, bipolar, the control link of the reflection contour in the circuit break in between the loopback PhED and L, to the base of which the standardized by amplitude closing pulses are sent from the out contact. The components not important for understanding, in particular, those ensuring the input signal amplification and digitization and also the transistor T operating point on its curve are not shown in the diagram for simplification.

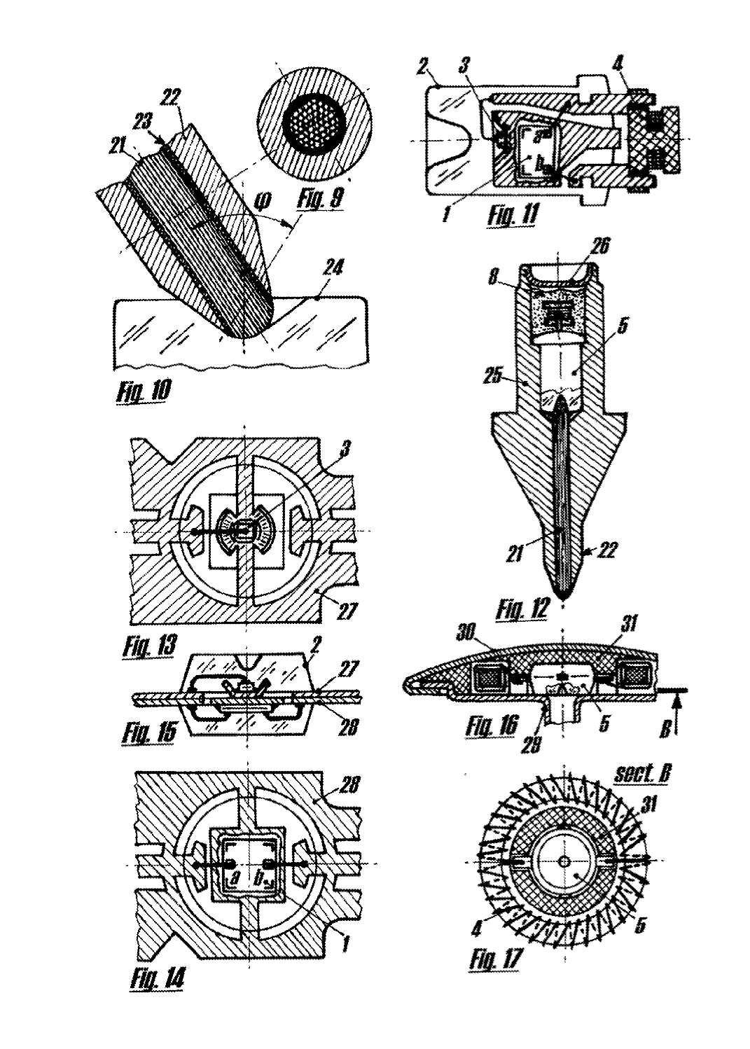

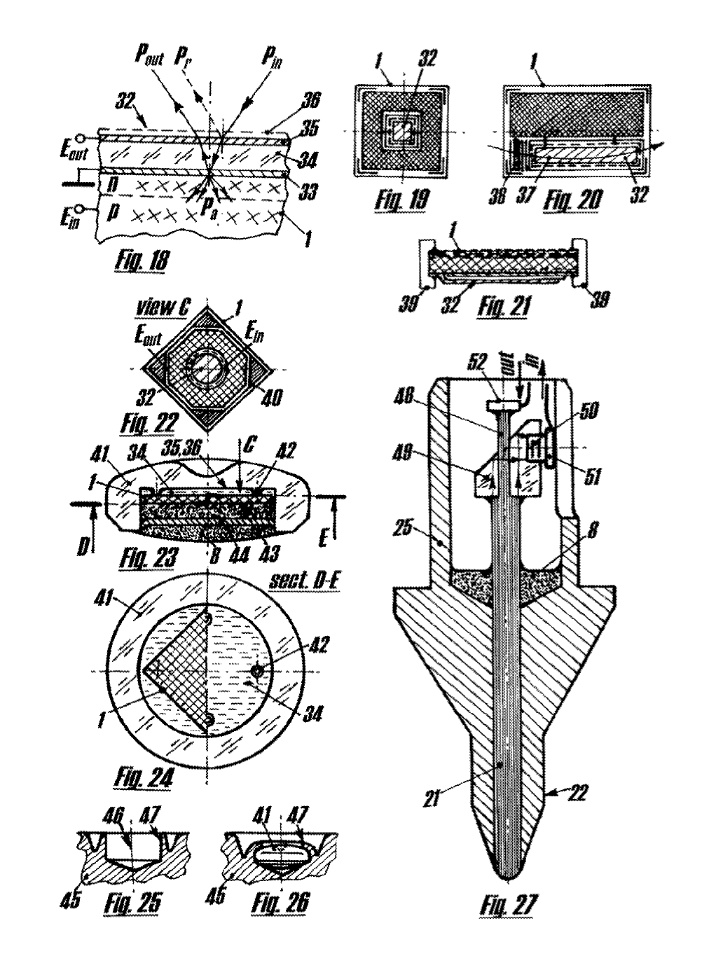

At delivering to the PhED active area, e.g. at ODC request, of rectangular pulses of the primary emission Pin being sent by the REC/READ, with energy Eᵢₙ (FIG. 2—top oscilloscope picture), the pulses of current I_{L} circulating at that in the reflection contour, via inductance L and open transistor T, due to known peculiarities of the transition processes in the circuits with inductance cannot have the same sharp raising edges as the pulses of photo-emf in the contour being generated at irradiation of PhED (almost repeating Pᵢₙ shape). It is obvious that they grow relatively slow exponentially and then equally slow (with the same time constant) fall down to zero (FIG. 2—central oscilloscope picture) upon passing of the primary emission pulses' falling edges. On integrating with respect to time the difference between the actual value of current in the circuit with inductance and current which would run in it if this equals zero, the value Q_{del} can be obtained—by physical sense—the charge which can be conditionally considered as delayed (or dynamically accumulated) in the reflection contour. Taking into account that with zero inductance L the current in the contour would be zeroed synchronously with ceasing of photo-emf action, integral over the time of the total value of current running in the intervals between pulses of the primary emission gives the value Qᵣₑₗ—of charge which can be conditionally considered as returned. According to Faraday's rule for determination of self-inductance current direction at ceasing of emf action and to the law of conservation of charge, the currents in the contour, with mutually inverse processes of charge accumulation and return, run through PhED in the same direction (in which it is opened), at that Q_{del} and Qᵣₑₗ are equal in magnitude and correspond with the areas hatched on the oscilloscope picture. Passage through the contour of charge Qᵣₑₗ, due to PhED material properties, is accompanied by generation of the secondary emission pulses Pout the energy of which Eₒᵤₜ (FIG. 2—bottom oscilloscope picture) determining confidence of their detection is proportional, with due account for quantum output, to the number of re-combined electron-hole pairs—to the charge. That's why the required value of charge is the input data for calculation of inductance L.

Wavelengths of the primary and the secondary emissions may be not coincident: the primary emission is reasonable to be selected such that it would be better absorbed in PhED material. The efficient work of parallel to the reflection contour power supply providing the IC with energy in amount sufficient for deciphering of Pᵢₙ and forming of Pout is facilitated by the fact that the shunting effect of L accompanied with current take-off from PhED is minimum at the beginning of the cycle, and is absent at the closed transistor T. The advantage of Schenkel-Willard pattern lies in its closed (with capacitor C₁) input excluding influence of the constant constituent Pᵢₙ which would not exist if the input signal was delivered, like RFID, not from the photo converter but from the antenna. If necessary, the quantity of constant voltage multiplication stages can be increased.

The design of ODC, the IC and the diode structure of which are mounted in perpendicular planes: the first on the lateral, and the second on the butt-end surfaces of one of the leadouts, is shown in FIG. 3. The ODC, like the most widespread design of the signalling LEDs, has the plastic collar casing 2 ending with convex butt-end in the form of collecting lens. The casing is formed through pouring, after installation, with the optically transparent compound of the head assembly—as against the optic guides, with three leadouts rather than with two, at that its middle leadout is the common crystal-holder for PhED 3 and the IC 1—the pad “common electrode” as per FIG. 1. The PhED 3, analogous by making to the crystals of signalling LEDs with emitting facets, is mounted on the butt-end of the head's middle leadout which, also similarly to LEDs is formed as reflector.

The contact pads a and b of the IC 1 are connected using the wire mounting jumpers as follows: the first one with the side surface of the head upper (as per FIG. 3) leadout (to the butt-end surface of which the PhED 3 contact pad is also connected using the wire mounting jumper), and the second one—with the side surface of the head shortest (bottom) leadout. Upon forming of the collar casing 2 the process jumper linking during installation the head leadouts is removed, and the leadouts are shortened to different length: the middle one as being not subject to external connections, almost to zero, and the extreme ones to minimum allowing to accomplish mounting of inductance L 4 on them, for example, through soldering. Thus the block-diagram as per FIG. 1 turns out to be structurally implemented to the full extent.

The design of inductance L 4 in main parts is analogous to the widespread designs of chip inductances for surface mounting on spool-shaped ferrite cores, except for the fact that the core is made not with rectangular but with circular mounting base in which there exist the metallized slots connected with winding, for the head extreme leadouts. The result is the compact-size design of the ODC just slightly exceeding in axial length the LED housing.

If the specifications for ODC allow substantial increase of axial length, then at initial stages of mastering of these items, beyond the casing 2, similarly to inductance L 4, there can be placed the axially stretched printing (film) microboard on which the whole—except for PhED—ODC pattern is mounted including with replacement of all or part of the outlined on FIG. 1 components of IC 1 with discrete components. As PhED, there can be applied a usual signalling LED of the corresponding design if it's acceptable characteristics in photovoltaic mode (not compulsorily on the intrinsic emission wave—in the conversion mode, the more useful is higher light absorption coefficient as compared to the emission mode) are established through experiment.

The described ODC in protected external decoration recommended for vending applications is shown in FIG. 4-6. The ODC 5 is enclosed into the collar holder 6 ensuring ease of handling them and its connection to the objects (merchandises) being marked. The collar holder 6 is a sufficiently long (for placement of label 7 with protective drawing and text data on the merchandise and/or with further bar and/or QR codes) plastic plate with internal cavity with which the two butt-end holes located along the plate intercommunicate. The front (bottom as per FIG. 4, 5) butt-end hole is of variable diameter: of maximum in the bottom (at output), of minimum in centre (at narrow belt) and of medium in the top (at inlet to inside). These diameters correspond with overall and mounting dimensions of the ODC 5 which through the internal cavity is inserted into the hole against stop to the belt and fixed there securely with pouring of polymer glue or compound 8. The diameter of front hole in the output part exceeds the diameter of the casing 2 of the ODC 5 to such a value that the gap is left between them sufficient for mating with hollow tubular optic guide 12 as part of REC/READ as per FIG. 8 being described below.

The ODC decorated in such a way is attached to a goods, in particular, threading through it (strapping it) a lace (with a lace) 10, further leading both lace ends through the rear butt-end hole (upper one as per FIG. 4, 5) into the internal cavity of collar 6 and tying them there with a reliable knot. The pass-through (e.g. oval) cross-section of the rear hole corresponds with thickness of the lace 9: it is large enough to let both ends of the lace pass freely into the internal cavity but is small enough that after tying of the lace ends to a knot, it would be impossible to withdraw the lace. Further the label 7 is glued enveloping the collar 6 and closing both the internal cavity with the knot on the lace and the front hole. For better quality of gluing, the front (bottom as per FIG. 4, 5) butt-end of the collar is rounded. On the label 7 fold above the front hole, through laser perforation there is applied the cross-shaped drawing 10 weakening mechanically the label 7 in this place in the way that at the first mating with REC/READ after gluing the edges of the front hole be framed with 4 petals.

The label 7 made and glued as described above, due to special properties of its material (self-adhesive film which once glued somewhere cannot be removed without being damaged), ensures efficient protection of the ODC against two kinds of unauthorized actions: transfer to another object (indicators are damage of integrity of the lace, damages of the drawing and/or the label material), and access to pre-recorded data for the purposes of reading and/or amending (indicator is the front hole is open). The ODCs of such decoration (by belonging, electronic ones: badges, labels, tags, seals etc.) can find many applications not only in vending but in many other industries.

It is reasonable to link to the described example of structurally finished ODC with AsROI the example of design of the corresponding REC/READ the particulars of which are the common channel for the primary and the secondary emissions and the common for transmission and receipt modes optically active diode structure. The front panel of such a REC/READ (FIG. 7) like coin boxes of vending machines comprises the tilted (for ergonomics reasons) slot 11 at the back of which there exist 2 pins: the sharply protruding hollow pin in the centre, the component of mating with the REC/READ, the tubular optic guide 12 with reflective inner surface, and the relatively short pin at the edge, the sensor of completion of mating 13.

As the ODC as per FIG. 4-6 is inserted into slot 12 of the REC/READ as per FIG. 7, 8, the optic guide 12 tears the cross-shaped perforations 10 of the label 7 (if not torn in advance) and drawing the formed 4 petals apart, lays them in the form of framing of the front hole edges. Heaving reached the stop, the optic guide 12 covers the jacket 2 of the ODC and the sensor 13 squeezes itself inside the casing 14 of the REC/READ with front butt-end of the collar 6. The start command produced here by the sensor 13 (the contact system is shown for clarity—actually the non-contact sensors are preferable) triggers working out by the electronic circuitry of the REC/READ 15 (shown like the ODC pattern in FIG. 1 as a block (hatched rectangle) with outlined components) of the commands in accordance with the protocol of data exchange with the ODC.

In the REC/READ pattern, same as in the ODC pattern, to support the optical communication bidirectional channel there is used the common for transmission and receipt modes optically active diode structure of material of, for example A₃B₅ group, allowing it to work both in LED (emitting) and in photodiode (converting) modes—16. But, the REC/READ as against the ODC is active, i.e. it receives energy from outside via the harness 17 linking it to a data addressee/source, e.g. to a checkout counter or a host computer. That is why its power supply capacity is substantially higher which allows through flexible adapting at the current moment of the REC/READ pattern in accordance with the mode, to use, in essence, the same PhED as the one in the ODC but with significantly higher efficiency both in transmission and in receipt modes.

The circuit board of REC/READ 15 comprises the switch box 18 (shown for clarity separate and contact-mechanical, and actually it is integrated and contactless-electronic) connecting in sequence the structure 16 to the out output of the request signals amplifier 19 (in transmission mode) or to in input of the response signals amplifier 20 (in receipt mode). Since both these amplifiers receive electric power from the circuit board 15, they can be constructed in the way that in transmission mode the current pulses close to maximum admissible be delivered to the structure 16, and in the receipt mode the structure 16 work, like the ODC, not in photovoltaic mode hardly highly sensitive but in much more efficient modes—the reverse-biased or even in avalanche modes (it is also reasonable to examine such possibilities for the known LED structures). For the switch box 18, the principle of construction is possible accepted in the radio positioning: the receipt and transmission circuits in no mode disconnect physically but in the transmission mode, the receiver input is locked automatically.

The other, in many points unique, class of external decorations of both ODC and REC/READ with AsROI can be obtained if as the optic guide with common channel for the primary and the secondary emissions in one of the devices there will be used the rigid fibre optic box being the bundle of paid in parallel fibre optic guides in common protective jacket, and sharpened and rounded on the external end, and in the other device, the optically transparent window with cavity of the corresponding rounding radius, intended for touching by the tip of the first device's optic guide.

The optic guide in the form of rigid fibre optic box is shown in FIG. 9 and FIG. 10 in cross and longitudinal sections, accordingly. In it, the core 21 can be outlined—the optic guide basis consisting of the bundle of laid in parallel glass fibres each of which has the glass coating with reduced refraction index (ensuring the effect of complete internal reflection in glass fibre), and the protective coating 22, e.g. a metal tube between which and the bundle there is introduced the buffer layer (layers) 23, e.g. of anaerobic sealant with sub-layer.

The core 21 can be made according to the technology being applied for manufacturing of the components of electro-optical image intensifiers (night observation devices)—of windows and microchannel plates. The arranged staggered bundle of glass fibres of diameter exceeding the required one is baked and in condition heated up to the temperature of glass softening is drawn many times, with the result that the bundle diameter decreases and the cross-sections of the initial fibres turn from round to near-hexagonal. The distinction from the basic technology lies in the fact that the final diameter of the bundle is obtained reduced (˜0.5÷1.0 mm) the quantity of fibres shall be selected from the process considerations, due to parallel work.

The optically transparent window of the second device 24 has the cavity mating by its spherical bottom with the rounding on the optic guide tapered end. The edges of the cavity are also conical, at that it is reasonable to select the angle near the cavity taper apex φ/2 larger than the angle near the optic guide taper apex, where φ is the maximum admissible angular deviation of the optic guide position from the normal when touching the cavity. This facilitates correct mating of the spherical surfaces in case of variations within the spatial angle φ of axis of the optic guide being introduced into the cavity (FIG. 10).

The design of ODC with AsROI as per FIG. 3 modified for application for communication of such an optic guide with it is given in FIG. 11. Modification includes its casing 2—now it ends not with convex but on the contrary, with concave butt-end in which the above described cavity is made. The angle near the cavity taper apex is selected relatively small since this ODC with external decoration is subject to permanent mating with the optic guide, consequently, here φ=0.

The external decoration of this ODC in the form of tapered tip of the digital pen (stylus) is shown in FIG. 12. The basis of decoration (turned housing) is the metal sleeve 25 in the form of mated tapers and cylinders and ending with the optic guide jacket 22. The sharpened and rounded internal (upper one as per FIG. 12) end of the core of the optic guide 21 is let inside the cylindrical cavity in the sleeve 25 inside which the ODC 5 is installed against stop. Prior to installation of the ODC, it is reasonable to inject into this cavity a drop of initial product of the transparent silicone elastomer in order to eliminate the air gap between the cavity and the optic guide core 21, and also to reliably fix the ODC 5. Further, it is reasonable to pour in the polymer compound 8 finally fixing the ODC 5 in the sleeve 25, and, in case of especially tough requirements for external effects, e.g. to ingress of aggressive liquids and/or sea water, to install and to weld along the perimeter the metal cap 26. In this way, there can be obtained the record-breaking resistant designs of ODC retaining operability also under extreme conditions, e.g. at depth under water.

The installation of the IC and the diode structure (PhED) of the ODC with AsROI is possible also in parallel planes bringing about the alternative class of structural versions with other capabilities. Here, the size of the IC crystal can be substantially larger; consequently, such versions are preferable first of all for ODCs with more complex functions, in particular, like smart cards, with data exchange crypto procedures.

PhED 3 is installed onto the jumper-crystal holder with beaded as reflector edges of the first output frame 27, and its left console output is connected by the wire mounting jumper with the contact pad of PhED 3 (FIG. 13). The IC is installed onto the jumper-crystal holder of the second output frame 28, and both its console leadouts are connected using the wire mounting jumpers with the contact pads a and b of the IC 1 (FIG. 14). Both frames are put together with rear sides in the moulding mould, whereby in the course of pressing of the mould prior to injection of compound, the internal electric connections are formed: the circuit “common”—by the crystal holders, and the circuit “contact a of the IC—PhED”—by the left console leadouts of the lead frames (FIG. 15). If necessary, reliability of the internal contacts can be increased by electrostatic welding in the appropriate places prior to their embedding into the mould. Upon shaping of the jacket of the body 2 of ODC, the process edges of both frames are cut with letting of the pair of diametric console leadouts of length sufficient for connection of the inductance cell L winding to them. The result is the ODC version in the form of a pellet of small axial length.

One of the reasonable external decorations of the ODC in the pellet version is in the shape of being open from the side of the tubular shank 29 of the head 30 of a hollow rivet or latch (FIG. 16). Inside the head 30 there is placed the plastic insert 31 with central hole for the ODC 5 and with diametric slots for its console leadouts. The inductance cell 4 is on the toroid ferrite core surrounding the ODC 5 and embedded in its turn into the insert 31. Since the beginning and the end of the inductance cell 4 shall be diametrically opposite, it is composed of two counter wound and parallel-connected sections each of which occupies the arc of 180° on the core (FIG. 17). Otherwise, the beginning and the end of single-section one-layer winding uniformly spread all over the core would converge which is exceptionally undesirable for this design. The edges of the head 30, upon completion of all the assembly operations are crimped around the boards of the shank 29 (FIG. 16) whereby the strong and integral metal jacket is obtained protecting reliably the ODC 5 against any mechanical damage. REC/READ for ODC in such a decoration shall be made in the form of a pen (stylus) with sharpened tip entering the tubular end of the shank 29.

The target 32 of the ODC with SROI in cross-section (FIG. 18) is the planar photodiode made as part of the IC 1 on the basis of single-crystal silicon, e.g. with p-type of conductivity, on the surface of which through diffusion or epistaxis techniques the n-layer has been formed. Above the n-layer, e.g. by the technique of indium-tin dioxide vacuum spraying, the first semi-transparent electrode 33 is applied. This electrode can be made, like usual silicon photo converters, yet in the form of metal comb (grid) but the semi-transparent conductive coating ensures uniformity of reflection by the entire surface of the target. The leadout of the electrode 33 is common (for transmission and receipt modes) and the input (for ODC circuit) voltage Eᵢₙ being generated during irradiation of this structure by the primary emission Pᵢₙ turns out to be applied to the ground of crystal of the IC 1.

All the subsequent structural components are further in relation to the photodiode basic structure and are only formed in those (as of now, the most prepared for implementation) embodiments of the ODC with SROI in which there are used not indirect (circuit, electric) but direct (structural, optic) techniques of the reflected emission modulation. The main of these components are the transparent optically active layer 34, for example, of ferroelectric, in which owing to Kerr-effect, under the action of electric field the rotation of light polarization plane occurs. For application of the control field, the second (modulating) semi-transparent electrode 35 is intended to which the output (from the ODC circuit) voltage Eₒᵤₜ is delivered. Above it, there can be formed the auxiliary layer (layers) 36, e.g. polarization, anti-reflection etc.

The incident (primary) emission Pᵢₙ (for clarity shown in FIG. 18 in the form of tilted beam) experiences absorption in each layer of the described structure of the target, and reflection from all interfaces of the materials having different absorbency. Naturally, the first reflection takes place at the target input. This constituent of the reflected emission (Pᵣ) is harmful, but must be taken into account since it is required to detect on the Pᵣ background the useful constituent of the reflected emission Pₒᵤₜ. The latter is formed in the lower depth of the structure through reflection from the first semi-transparent electrode 33 and passing (with modulation) through the optically active layer 34. The most part of the incident emission Pᵢₙ, though, is not reflected but absorbed (scatters) in the target base, in particular, in p-n transition (Pₐ) thus triggering there the processes of charge carriers' photo generation and, correspondingly, of energy photovoltaic conversion.

The target location on the IC planar surface can be different, and according to it, different can be the structural version of single-piece ODCs with SROI. If the target 32 is located on a common planar surface with the IC 1 non-volatile memory circuit boards in the centre (FIG. 19), the result is the compact-size and the simplest as regards structure and technology version of the ODC. Its sub-embodiment is the marginal location of the target 32 (FIG. 20)—in this way there can be made, in particular, the dedicated ODCs intended for integration into laser optic discs (CD/DVD) in order to protect the data contained in them—the more advanced analogues of NcIMC as per [10]. Since the REC/READ for them is the optic head of the corresponding disc drive, the target 32 of them shall be extended along the arc-shaped trajectory of motion of the interrogating (laser) beam 37, and also there shall be formed the auxiliary optoelectronic components 38. The ultimately miniaturized by area ODC can be obtained when the target is located on the IC 1 rear surface, opposite to that on which the non-volatile memory circuit boards are located (FIG. 21). Eᵢₙ and Eₒᵤₜ are transferred via the jumpers 39 between the components located on the opposite sides of the crystal.

The substantial simplification of the ODC IC manufacturing technology and expansion of the range of materials being used is possible if at least one of the further structural components of the modulator is brought onto the transparent dielectric substrate carrying the IC, with connection of it (them) to the circuitry components using the assembling techniques being used in the hybrid film technology. The example of the ODC structural version in which all the further structural components of the modulator—the optically active dielectric (in this embodiment, the liquid one) and the semi-transparent electrode—are brought outside the silicon IC ensuring the possibility to manufacture it with no deviations from the basic technology, is given in FIG. 22-24.

The target 32 of such an IC 1, the usual photodiode, is linked to its topology (FIG. 22) only by voltage Eᵢₙ being generated. The output voltage Eout being delivered to the modulator is led out to the external conducting frame with four contact pads 40 in the corners. The structural basis (micro-housing) of this ODC is composed of the lens-shaped transparent dielectric substrate-capsule 41 close in size and external configuration to ruby jewels for wrist mechanical watches. For the most critical applications, the capsule 41 can be analogous to the watch jewels also in material (artificial ruby or leucosapphire), but the most economically reasonable material of the capsule is seen to be the thermoplastic based upon transparent high-strength and size-stable polycarbonate being used for manufacturing of bases of laser optic discs (CD/DVD). In the latter case, through flow moulding in cluster-type moulds, quite easily there can be implemented the configuration of cavity in the capsule 41—the cylindrical depression with four contact projections (posts) 42 in the plane of the bottom, being located similarly to location of the contact pads 40 in the IC 1 topology and equal in height to the required thickness of the optically active layer 34 (FIG. 23, 24).

The modulator layers (the main layer, electrically conductive—35, and, if necessary, the auxiliary one, in particular, the polarization sub-layer—36) are in sequence applied onto the cavity bottom in the capsule 41 covering also the projections 42, upon which the IC 1 is installed onto them by the contact pads 40 using the ultrasonic welding. The optically active liquid dielectric, particularly, the liquid crystal material 34 is injected in the form of a drop from one of the IC 1 edges, and being drawn by the surface tension forces into the capillary gap between the IC 1 planar surface and the capsule 41 bottom, turned out to be in between two electrodes the first of which is the target surface (“common” as per FIG. 18), and the second one is the semi-transparent electrode of the modulator 35 being, due to connections of the projections 42 with the pads 40, under potential Eₒᵤₜ. In this method, the ODC is formed being the product of basic technologies not only by IC but also by the modulator, actually the single pixel of batch-produced LCoS (Liquid-Crystal-on-Silicon) micro displays being used in computer monitors in the form of goggles.

The ODC is decorated completely and sealed reliably through successive installation into the cavity of capsule 41, against stop to the rear surface of the IC 1 crystal, of elastic sintered disc 43 compensating the relatively high (towards solid bodies) temperature coefficient of the liquid dielectric 34 volume dilatation, and of foil disc 44 ensuring impermeability. The disc 44 is fixed in the capsule 41 cavity by the drop of dielectric compound 8 applied over it.

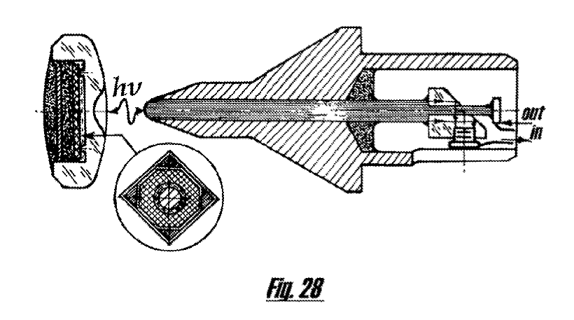

The miniature ODC externally similar to watch jewels can also be installed into the objects being equipped) (from critical motor vehicle or aircraft spare parts and medical items for which not only protection against infringement products is reasonable but also keeping of electronic log-book, to the jewellery/bijouterie items which can be casually used as the backup—always with the owner—carrier of personal/medical data and/or electronic means of payment) through the method similar to one being used in watch production. In the item 45 made of metal or high-strength thermoplastic polymer, the blind hole is made of the relevant size in the form of a collar (holder) 46 with boards for crimping 47 (FIG. 25). Into it, there is embedded the sealed capsule 41 of the assembled and tested ODC upon which the boards 47 are crimped (curled) thus reliably protecting the ODC against falling out (FIG. 26). If the item 45 is a jewellery item, the hole 46 can be made in the form of a holder similar to holders for other (decorative) inserts of the item, and the external surface of the ODC collar 41 is also given the decorative, e.g. faceted shape in the form of a strass.

The REC/READ for ODC with SROI (FIG. 27) can be made in the form of a tapered pin of a digital pen (stylus) similar to the version of ODC with AsROI given in FIG. 12. The basis of decoration (ground housing) is close in shape to the above described, metal sleeve 25 in the form of mated cones and cylinders and ending with the jacket of optic guide 22 in the form of a stretch of a rigid fibre optic box being the bundle of parallel laid fibre optic guides. The optic guide is fixed in the sleeve 25 with dielectric compound 8. The distinction is in the fact that the optic guide 22 comprises on its internal end the shank 48 with cross-section smaller than that of its main part. It is passed through the transparent prism 49 with metallized surface ensuring reflection of light impressed inside the prism through its bottom facet. To the latter, the butt-ends of fibres adjoin which are in the optic guide 22 circumferential peripheral area intended for channelling of the secondary (response) emission of the ODC. This emission (conditionally designated with arrows) reflecting from the 45° deflected top facet of the prism 49, turns 90° and upon passing through the obstructing (if necessary) auxiliary system of lenses 50 falls on the photo perceptive surface of the receiving instrument 51 which forms the input signal in for the REC/READ circuit board.

The system of lenses 50 is necessary in cases when the receiving instrument 51 photo perceptive surface is the matrix one, at that the image of the optic guide 22 peripheral area shall be focused on it, e.g. at presence as the option of the REC/READ operation computer mouse mode.

The transmitting instrument 52, for example, the LED in the version intended for butt mating with the fibre optic communication line is installed on the butt-end of the shank 48, and to it there is delivered the output signal out from the REC/READ circuit board. It is obvious from the structural pattern given in FIG. 27 that emission of the transmitting instrument 52 can fall on the receiving instrument solely by going outside along the optic guide 21 core, reflect from something that supports the optic guide 21 external end or towards which it is directed, and being scattered at reflection, return again inside along its periphery—now as the secondary emission. Thus the task of spatial separation in REC/READ of request and response signals is solved.

It goes from the same structural pattern that the edge of the optic guide 21 peripheral area left (as per FIG. 27) part being reflected to the receiving instrument 51 photo perceptive surface turns out to be in the shank 48 shadow. This is the disadvantage of this simplest REC/READ embodiment—but not essential for the most part of applications since with due account for the secondary emission's reflection also from the metalized front and rear facets (parallel to the plane of the drawing) of prism 49, actual loss of its energy turn out to be minor. But if it is undesirable or inadmissible, e.g. when the REC/READ works in the computer mouse mode requiring detail recognition of the optic guide 21 peripheral area image, the prism 49 with one tilted mirror facet shall be replaced with a pyramid having several such facets, and install opposite to each of mirror facets one receiving instrument, and using the REC/READ processing part, process jointly the peripheral area electronic images being formed.

The information interaction of complementary optoelectronic devices of the set through the short-range optical communication methods considered above is explained by FIG. 28 (to the abstract) compiled of the components of FIG. 22, FIG. 23, and FIG. 27, as exemplified by ODC and REC/READ with SROI. The specified devices are shown in various scales—the ODC with much greater magnification than the REC/READ, and for clarity, actually zero-gap is shown in between them in which the electromagnetic emission quanta hv steer. It must also be noted that the shown co-axial location of the ODC and the REC/READ is just one of the embodiments which is not compulsory (see FIG. 10).

Since ROI both in synchronous and asynchronous variants is functionally similar to a single-wire bidirectional signalling line linking TM and TP, the protocol of data exchange between ODC and REC/READ can be based upon the known principles described in [2].

But direct lift of these principles is unreasonable since the series of specific peculiarities of ROI requires at least fundamental refining of these. In particular, the known protocol consists of three main cycles—initialization (identification), recording, and reading. For ROI, the initialization cycle in analogous form is not required since the start command in the REC/READ is produced by the relevant sensor. Hardly also the impulse relative time technique of data coding being used in the known protocol shall be retained—probably, the phase-pulse technique at which all the light pulses have the same width and bear equal portions of energy will be preferred.

On the other hand, it is reasonable to retain such principles as, in particular, the data receipt and transmission for discrete time intervals, segments, and also monitoring of their integrity using the cycling redundancy checks (CRC). Diversion of data receipt and transmission cycles by different segments removes the illusory contradiction between simultaneity of consecution of the request and the response signals, in particular, through SROI and the fact that processing in the ODC of the request data and producing of the response data require time. For any ROI kind, the request signal being sent from the REC/READ to the ODC at response of the latter is the carrying only energy but not the data sequence of sync pulses (strobes), within the duration of each of which the REC/READ waits for delivery of sequential digit of previously formed response binary code. The coded request comes from the REC/READ to the ODC in another segment when the latter works only for receipt. Besides, data exchange through ROI between the ODC and the REC/READ can also be accompanied by disturbance of optical contact since disturbance of electric contact can occur between TM and TP. That is why monitoring of integrity of the data being received is necessary in one form or another.

For most part of potential application scopes it is reasonable that the ODC non-volatile memory be divided into sectors with different access attributes, such as, e.g. Read Only (RO), Add Only (AO), and/or Read and Write (RW). In particular, it is reasonable to record into the RO sector in the course of manufacturing of ODC their serial numbers, the unique code combinations unavailable for being changed externally. This will ensure copy-protection for each ODC, the necessary condition of security in use of monotypic instruments for identification/authentication of objects (items) or the subjects (users).

### Data Sources

1. Touch Memory—Electronic Identifying Key. Glossary for security systems. http://www.polyset.ru/glossary/Touch_Memory.php
2. Touch Memory—Electronic Identifier. Articles on electronics. http://kazus.ru/articles/60.html
3. RFID Radio Frequency Identification. RFID Technology. http://rfic-ru.ru
4. RFID and Alternative Techniques of Automatic Identification. http://ru.wikipedia.org/wiki/RFID
5. What Is a Smartcard? http://guarda.ru/guarda/data/card/txt_09.php
6. Near Field Communication. http://ru.wikipedia.org/w/index.php?title=NFC
7. A Digital Pen. http://www.3dnews.ru/2128/print
8. Infrared Data Association. http://ru.wikipedia.org/w/index.php?title=IRDA
9. V. V. Antonov, A. A. Vilisov et al. Semiconductor Optoelectronic Instrument. Mechanical patent of Russia RU No. 2032965.
10. V. A. Konyaysky, V. I. Livshits. Non-Contact Integrated Microcircuit. Mechanical patent of Russia RU No. 2245591, see also International Application PCT No. WO 2006/036080.

1. A method of short-range communication between two optoelectronic devices interacting by the principle Master-Slave (hereinafter referred to as M-S), based upon that the primary emission source is only placed into the first, M-device, and the second, S-device is used in passive mode at which it receives power resulting from photovoltaic conversion of energy of the absorbed part of the primary (incident) emission being sent by the M-device at request of the S-device, and in its turn, responds the request through modulation of the secondary (reflected or in other method returned to M-device) part of its emission, WHEREIN to accomplish data exchange between the devices in accordance with the established protocol, both devices are brought to touch in the way that between the active structure as part of the M-device, the optical transponder, and the active structure as part of the S-device, the target, the optic guide be formed concentrating emission in the communication channel between the devices and limiting its distribution into the environment, upon which on the start command being generated by the M-device, the data exchange is accomplished, in that as the target in the S-device there is used the functional area of the reversing (reversible) optoelectronic instrument capable of working both as the receiver (energy converter) of the primary emission and as the electrically controlled transmitter (modulator) of the secondary emission.

2. The method of claim 1, WHEREIN the start command initiating the data exchange, is generated in the M-device automatically at touch of the both devices, for which purpose the sensor of pressure exerted on it is included into the M-device composition.

3. The method of claim 1, WHEREIN the optic guide is formed with common channel for the primary and the secondary emissions, and the primary emission request signals and the secondary emission response signals are separated by time with construction of the S-device circuit in the way that in it, the leading edges of the response pulses would form behind the falling edges of the request ones.

4. The method of claims 1, 3, WHEREIN the optic guide with common channel for the primary and the secondary emissions is formed through connection to one of the devices of the hollow tube with reflecting inner surface, enveloping the active structures of the both devices: of the first one—constantly, and of the second one—temporarily (for the period of touch).

5. The method of claims 1, 3, WHEREIN the optic guide with the common channel for the primary and the secondary emissions is formed through connection to one of the devices of the rigid fibre optic box being the bundle of laid in parallel and working together fibre optic guides in common protective jacket, sharpened and/or rounded on the external end which shall touch the optically transparent window (cavity of the corresponding rounding radius in the optically transparent window) of the second device.

6. The method of claim 1, WHEREIN the optic guide is formed with separated channels for the primary and the secondary emissions through connection to the M-device of the rigid fibre optic box being the sharpened and/or rounded on the external end, which shall touch the optically transparent window (the cavity of the corresponding rounding radius in the optically transparent window) of the S-device, bundle of laid in parallel but working separately fibre optic guides in common protective jacket, at that via the group of fibres located in the centre (in the core) of the bundle, the primary emission is channelled, and via the group of fibres located in periphery (in circumferential zone adjacent to the jacket) of the bundle, the secondary emission is channelled.

7. The method of claims 1, 6, WHEREIN on the internal (connected to the M-device) end of the optic guide with separate channels for the primary and the secondary emissions the shank is made of cross-section smaller than cross-section of its main part—such that it would only accommodate the core intended for channelling of the primary emission, and the butt-ends of the peripheral fibres intended for channelling of the secondary emission would stay in the zone of step-wise transition from the main part to the shank, at that the optical transponder of the M-device is built with separate receiving and transmitting structures (optoelectronic instruments) according to the optical pattern ensuring separation of the primary and the secondary emissions by the relevant instruments with sufficient level of optical isolation between them.

8. An optoelectronic data carrier (hereinafter referred to as ODC) being the recorder/reader (hereinafter referred to as REC/READ) receiving repeater, receiving its power as a result of photovoltaic conversion of energy of the emission being sent by the REC/READ at request of the carrier and responding the request through modulation of the secondary (reflected or in other method returned to the REC/READ) emission, WHEREIN it is made in the form of a hybrid micro-assembly comprising the silicon integrated circuit (IC) with the circuit boards of non-volatile memory to which there are connected in the form of closed circular circuit the optically active diode structure of material, for example, of A3B5 group allowing it to work both in photodiode (converting) and in light-emitting diode (LED) (emitting) modes, and the inductance cell (microcell) the inductance of which is determined by the criterion of sufficiency of energy accumulated in its magnetic field for one current pulse, for formation of the response pulse of light being emitted by the structure in LED mode upon ending of the brightening pulse due to the fact that current cannot cease immediately in the circuit with inductance, at that the IC comprises the electronic key disconnecting the mentioned circuit in cases when the binary digit of the digital sequence being transferred to the instant interval is such that formation of the response pulse is not required.

9. The ODC of claim 8, WHEREIN the IC and the diode structure in it are mounted in perpendicular planes: the first one on the side surface, the second one on the butt-end surface of at least one of the leadouts, and are poured (moulded) together with optically transparent compound, and the inductance cell is installed outside on the leadouts' stretches of minimum length put out of the pouring (moulding).

10. The ODC of claims 8, 9, WHEREIN it is enclosed into the collar holder ensuring ease of its handling and/or of its connection to the item being marked, and protected against unauthorized actions with destroyed-when-removed adhesive appliqué with protective (hard-to-copy) drawing enveloping the collar, at that at the level of the carrier, there are made in the appliqué the perforations tearing at the first action of recording/reading (initialization of the carrier) by the end users.

11. The ODC of claims 8, 9, WHEREIN it is enclosed into the tapered tip of a digital pen (stylus) and mated inside with the passing along the tip axis rigid fibre optic box being the bundle of laid in parallel and working together fibre optic guides in common protective jacket the external butt-end of which, like a ball tip, is machined to a sphere.

12. The ODC of claim 8, WHEREIN the IC and the diode structure in it are mounted in parallel planes on the opposite faces of two lead frames put together with rear sides in the way that the leadouts subject to internal connections turn out to be superimposed (overlaying) and are jointly poured (moulded) with the optically transparent compound in the form of miniature short cylinder (pellet), at that the external contours of the frames and the leadouts (process ones) not subject to external connections are removed after pouring (moulding).

13. The ODC of claims 8, 12, WHEREIN it is enclosed into the opened from the side of the tubular shank head of hollow rivet or latch (button) as part of the personal-use item (item's casing) being equipped with the ODC and the inductance microcell is made on the circumferential (toroid) core and installed outside in the same plane with the ODC located in the core central hole.

14. An ODC being the REC/READ receiving repeater receiving its power as a result from photovoltaic conversion of energy of the emission being sent by the REC/READ at request of the carrier and responding the request through modulation of the secondary (reflected or in other method returned to REC/READ) emission, WHEREIN it comprises the non-volatile memory circuit boards and the optically active structure operating solely in photodiode (converting) mode, and at least one further structural and/or circuitry component ensuring modulation of emission reflected from the diode structure, at that of all the above mentioned components, at least the non-volatile memory circuit boards are implemented as part of the silicon IC.

15. The ODC of claim 14, WHEREIN the further components ensuring modulation of the reflected emission—solely circuitry ones—as part of the controller governing in transmission mode the diode structure electric load for the purpose of modulation of the reflected emission by the parameter sensitive to the share of absorbed energy extracted from the structure in converted (electric) form.

16. The ODC of claim 14, WHEREIN the optically active diode structure is implemented as part of the silicon IC on its common planar surface with the non-volatile memory circuit boards.

17. The ODC of claim 14, WHEREIN the optically active diode structure is implemented as part of the silicon IC on its second (rear) planar surface—opposite to that on which the non-volatile memory circuit boards are located.

18. The ODC of claim 14, WHEREIN the optically active diode structure comprises the external semi-transparent electrode included into the circuit as common for receipt and transmission modes, over which using the known process techniques there are applied further structural components in the form of electrically controlled optically active layer made, for example, of ferroelectric or liquid-crystal dielectrics, and also the second semi-transparent electrode included into the circuit as the modulator for transmission mode.

19. The ODC of claims 14, 18, WHEREIN at least one of further structural components is located on the transparent dielectric substrate carrying the IC and is connected to its circuit board using the assembling techniques being applied in hybrid film technology.

20. A REC/READ comprising the optical transponder sending the primary emission to ODC at its request and receiving the secondary (reflected or in other method returned to REC/READ emission from ODC at its response and the system of request and response signals' separation, WHEREIN it comprises common for transmission and receipt modes optically active diode structure of material of, for example A3B5 group, allowing it to operate both in LED (emitting) and in photodiode (converting) odes, and the electronic system of time separation of request and response signals in the form of a switch box connecting alternatively the optically active diode structure to the request signals amplifier output or to the response signals' amplifier input.

21. The REC/READ comprising the optical transponder sending the primary emission to ODC at its request and receiving the secondary (reflected or in other method returned to REC/READ) emission from ODC at its response, and the system of request and response signals separation, WHEREIN it comprises the optical system of spatial separation of request and response signals in the form of a stretch of the rigid fibre optic box being the bundle of laid in parallel fibre optic guides, which is sharpened and/or rounded on its external end, and on the internal end, comprises the shank of cross-section smaller than cross-section of its main part—such that it would only accommodate the core intended for channelling of the primary emission, and the butt-ends of peripheral fibres intended for channelling of the secondary emission would be in the zone of step-wise transition from the main part to the shank, at that the shank is passed through the hole in at least one mirror tiled relative to optical axis in the way that peripheral fibres' butt-ends would be displayed to the photo perceptive surface of at least one receiving (converting) instrument of the transponder installed opposite to the mirror near the fibre optic box, and the transmitting (emitting) instrument of the transponder, a LED or a laser, is installed on the shank butt-end put outside the mirror (system of mirrors).

22. The REC/READ of claim 21, WHEREIN the fibre optic box's shank is passed through the central (intersecting the apex) hole in the pyramid with mirror facets opposite to each of which there is installed the separate receiving (converting) instrument.

23. The REC/READ of claim 21, WHEREIN its circuit board comprises the dedicated for image processing digital signalling processing unit (DSPU) allowing it to operate in real time—as further option, independently of ODC—in the mode of graphic manipulator (analogue of optic mouse), at that to the DSPU input there is delivered the digitized image of the fibre optic box circumferential area obtained from several receiving instruments (for pyramid-shaped system of mirrors), or from at least one receiving instrument made in the form of cluster-type matrix under conditions of illumination of the supporting surface, through the fibre optic box core, by the transmitting instrument operating in continuous mode (illumination mode).

24. REC/READ of claims 21-23, WHEREIN it is made in the form of a pen (with further pen point) and comprises the independent battery and also the typical module of wireless radio frequency interface (e.g. Bluetooth) for communication with a host computer.
